(19) United States
(12) Patent Application Publication
(10) Pub. No.: US 2012/0023397 A1
(43) Pub. Date: Jan. 26, 2012

(54) INTERACTIVE WEBSITE

(76) Inventor: JOSHUA LEICHTBERG, Reno, NV (US)

(21) Appl. No.: 13/188,115

(22) Filed: Jul. 21, 2011

Related U.S. Application Data
(60) Provisional application No. 61/366,479, filed on Jul. 21, 2010.
(60) Provisional application No. 61/374,564, filed on Aug. 17, 2010.

(51) Int. Cl. G06F 17/00

(52) U.S. Cl. 715/234

(57) ABSTRACT

A method of an interactive website is provided that assigns information to each of a plurality of screen blocks for a particular geographical region. The information for each of a first subset of the screen blocks is associated with a different entity within the geographical region and the information for each of a second subset of the screen blocks is associated with a different entity within or outside the geographical region. The method further generates a web page with the screen blocks located on the web page and with the information associated with each of the screen blocks configured to appear when prompted. The screen blocks may include both blank screen blocks and image screen blocks containing images. The user may adjust, filter, search through, and organize the appearance of the screen blocks on the web page.

### CROSS-REFERENCE TO RELATED APPLICATIONS

This application claims the benefit of U.S. Provisional Application Ser. No. 61/366,479, entitled “Interactive Website,” filed on Jul. 21, 2010; this application claims the benefit of U.S. Provisional Application Ser. No. 61/374,564, entitled “Interactive Website,” filed on Aug. 17, 2010, both of which are expressly incorporated by reference herein in their entirety.

### BACKGROUND

1. Field

The present disclosure relates to the World Wide Web environment and, more particularly, to an interactive website.

2. Description of Related Art

The World Wide Web includes a system of Internet servers that support specialized formatted documents. The documents are called web pages. Every web page is identified by a unique Uniform Resource Locator (URL). A web page is a document or resource of information that can be accessed through a web browser and displayed on a monitor or mobile device. Web pages may be static files stored within the web server's file system or dynamically created files generated by the web server. Web pages may be in various formats supported by a browser, such as, for example, Hypertext Markup Language (HTML) or eXtensible HTML (XHTML), and may include embedded code, such as JavaScript or Java applets. Websites are increasingly providing means for allowing people to network together and for facilitating business advertising. There is a need in the art for additional means for facilitating user networking and business advertising.

### SUMMARY

In an aspect of the disclosure, a method, an apparatus, and a computer program product for providing an interactive website assigns information to each of a plurality of screen blocks for a particular geographical region. The information for each of a first subset of the screen blocks is associated with a different entity within the geographical region and the information for each of a second subset of the screen blocks is associated with a different entity within or outside the geographical region. In addition, a web page is generated with the screen blocks located on the web page and with the information associated with each of the screen blocks configured to appear when prompted.

### BRIEF DESCRIPTION OF THE DRAWINGS

FIG. 1 is a diagram illustrating the architecture of a distributed computer system.

FIG. 2 is an illustration of a first map page of an exemplary interactive website.

FIG. 3 is an illustration of a second map page of the exemplary interactive website.

FIG. 4 is an illustration of a screen block page.

FIG. 5 is a first illustration of a collage page including blank screen blocks and image screen blocks.

FIG. 6 is a second illustration of the collage page including blank screen blocks and image screen blocks.

FIG. 7 is a first illustration of a destination map page.

FIG. 8 is a second illustration of the destination map page.

FIG. 9 is a third illustration of the destination map page.

FIG. 10 is a flow chart of an exemplary method of the interactive website.

FIG. 11 is a flow chart of an exemplary method of the interactive website.

FIG. 12 is a flow chart of an exemplary method of the interactive website.

FIG. 13 is a flow chart of an exemplary method.

FIG. 14 is a diagram illustrating another architecture of the distributed computer system.

### DETAILED DESCRIPTION

The present invention is described more fully hereinafter with reference to the accompanying drawings, in which various aspects of an interactive website are shown. This invention, however, may be embodied in many different forms and should not be construed as limited by the various aspects of the interactive website presented herein. The detailed description of the interactive website is provided below so that this disclosure will be thorough and complete, and will fully convey the scope of the present invention to those skilled in the art.

The detailed description may include specific details for illustrating various aspects of an interactive website. However, it will be apparent to those skilled in the art that the invention may be practiced without these specific details. In some instances, well-known elements may be omitted to avoid obscuring the inventive concepts presented throughout this disclosure. Various aspects of an interactive website may be illustrated with reference to one or more exemplary embodiments. As used herein, the term “exemplary” means “serving as an example, instance, or illustration,” and should not necessarily be construed as preferred or advantageous over other embodiments of the interactive website disclosed herein.

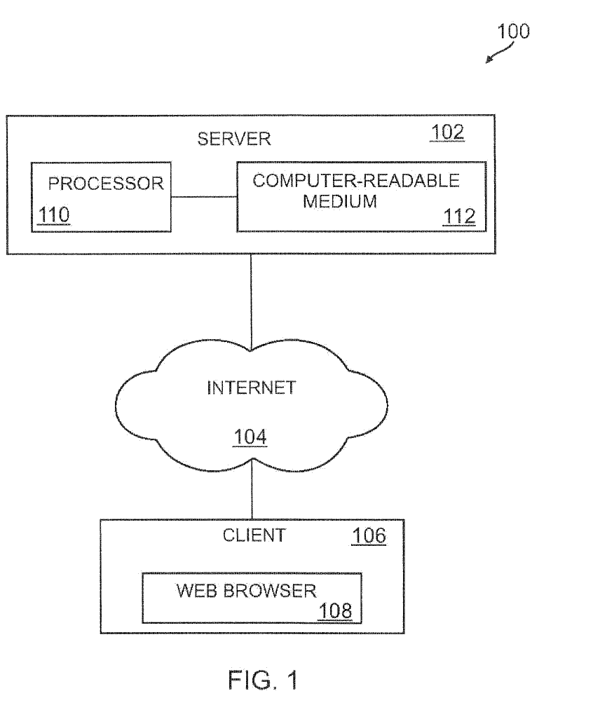

FIG. 1 is a diagram 100 illustrating the architecture of a distributed computer system. As shown in FIG. 1, a server includes a processor 110 and a computer-readable medium 112. The processor 110 and the computer-readable medium 112 may be referred to collectively as a processing system. Through executable code and web pages stored in the computer-readable medium 112, the processor is configured to provide access to an interactive website via the Internet 104 to a client computer 106. A user may access the interactive website via a web browser 108 running on the client computer 106. The client computer 106 may be implemented in various embodiments in accordance with the disclosure, such as a personal computer or a mobile device including a wireless cellular phone or a tablet computer.

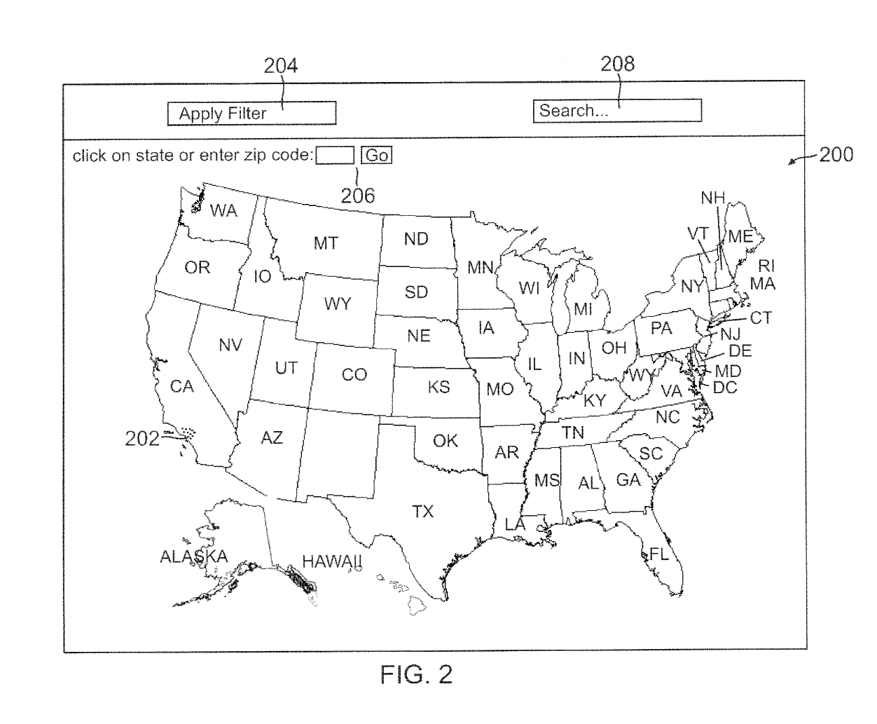

FIG. 2 is an illustration of a first map page 200 of an exemplary interactive website. As shown in FIG. 2, a map is provided to a user through the web browser 108 running on the client computer 106. The map may include a map of the world or a subsection of the world, such as a map of the United States. The map includes regions that may be selected in order to view an enlarged map of the regions. For example, if the map is a map of the world, the page 200 may allow users to select particular continents or countries on the map, and if the map is a map of the Unites States, the page 200 may allow users to select particular states on the map. As the user moves a mouse cursor over the map, particular regions of the map may be highlighted. For example, if the map is a map of the United States, particular states may be highlighted as the mouse cursor moves over the state. On the map are dots or markers 202 indicating users that are online and their physical locations on the map. The marker 202 for a user or group of users appears when the user or group logs into the system and disappears when the user or group logs off the system. The user may use a filter 204 to display only a subset of the users that are online. That is, the user may filter the data shown on the page 200 based on a plurality of filter options in order to show only those dots or markers that correspond to the filter options. The filter options may include gender, age, hobbies or interests, business interests, marriage status, and other criteria that a user would consider useful for narrowing selectivity of people. In selection area 206, the user may enter a zip code or other information identifying a particular region in order to display a web page associated with the particular zip code or region. The user may use a search 208 to display a list of users satisfying the search parameters.

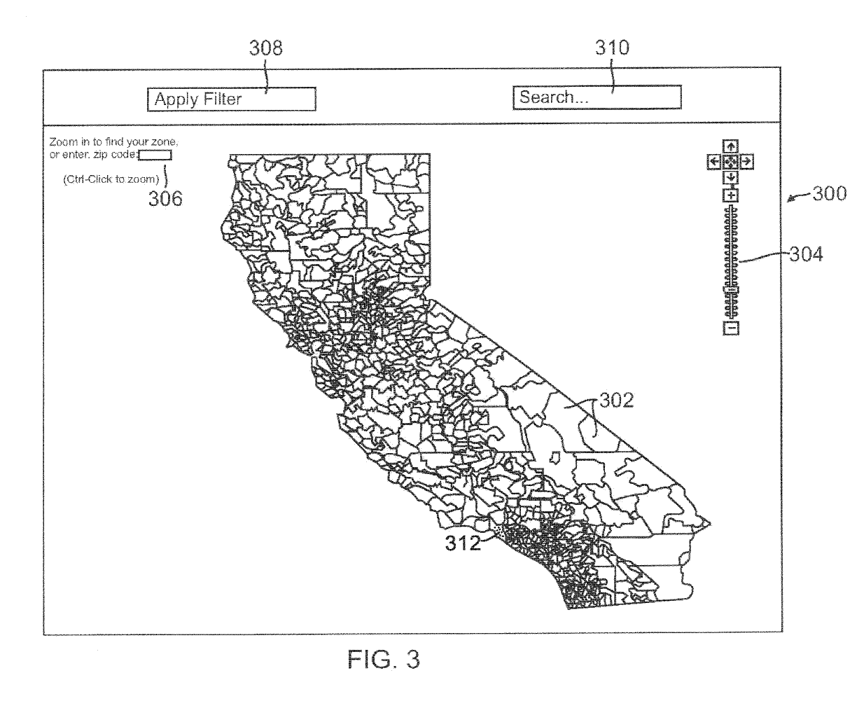

FIG. 3 is an illustration of a second map page 300 of the exemplary interactive website. The page 300 is an enlarged region displayed upon a selection in page 200. As shown in FIG. 3, an enlarged map of California is provided. The map includes region delineations 302, each of which a user may select to view an enlarged map of the particular region. The delineations may be arbitrary or may be based on known delineations, such as for example, county or zip code delineations. The page 300 may include an ability to move the map and zoom into and out of the map 304. In selection area 306, a user may enter a particular region, such as a zip code, so that a web page associated with that particular region may be viewed. On the map are dots or markers 312 indicating users that are online and their physical locations on the map. Through a filter 308, the user may filter the data shown on the page 300 based on a plurality of filter options in order to show only those dots or markers that correspond to the filter options. Through a search 310, a user may display a list of users satisfying the search parameters.

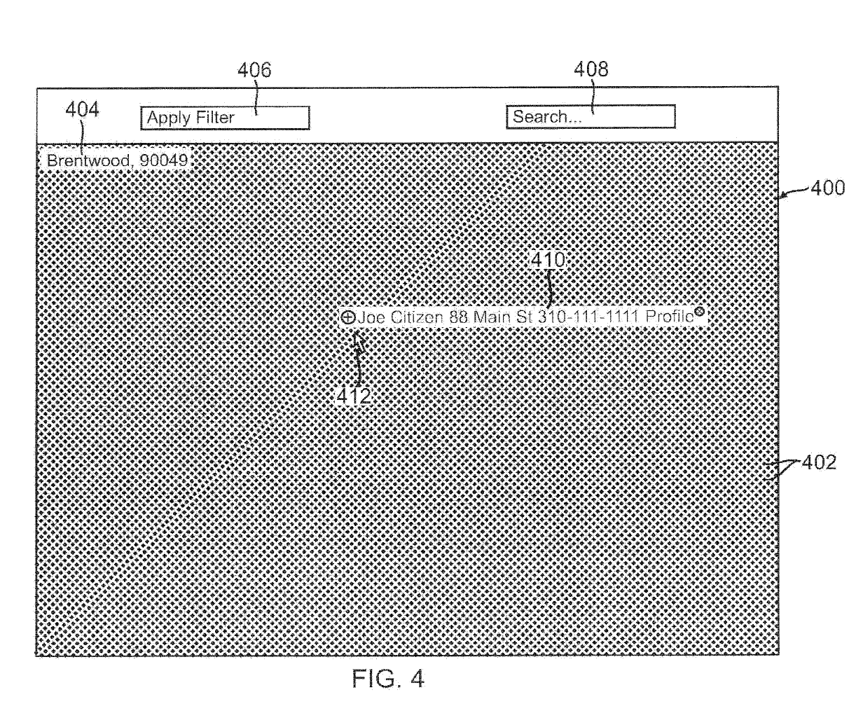

FIG. 4 is an illustration of a screen block page 400. The screen block page 400 contains only blank screen blocks. The blank screen blocks may include a border delineating each of the screen blocks, or the blank screen blocks may be borderless. When a user selects the region delineation 302, which as discussed supra may be based on zip code, or when the user selects and enters a particular region in the selection areas 206 or 306, the screen block page 400 is displayed. The screen block page 400 includes a plurality of screen blocks 402 associated with a particular region, which in FIG. 4 is a zip code. The zip code associated with the screen blocks 402 in the screen block page 400 may be displayed in text 404. When a mouse cursor 412 moves over a particular screen block, a balloon 410 containing information associated with the screen block 402 is displayed. The balloon 410 may be pinned to the page so that when the mouse cursor 412 moves away from the block, the balloon 410 remains. Each screen block 402 may be associated with a particular person who lives within the zip code. Each balloon 410 may contain information about its associated particular person, such as publicly available information published in telephone directories. The screen block page 400 may include one screen block 402 for every person known to reside within its particular zip code or region. Each person living within the zip code may make available additional information that may be displayed via the screen block page 400. The information may include photos, names, addresses, phone numbers, music, additional contact or personal information, links (e.g., a link to a profile or for contacting the person), and/or other information associated with a user or information a user would like to provide. The information may be displayed while playing music designated by the member. The links displayed may include an interface for sending e-mail or communicating through instant messaging (IM). Some part of the information may be limited to a certain number of characters. The locations of screen blocks 402 may be randomized on the page, and therefore each time the screen block page 400 is generated for a viewer, the screen block 402 associated with a particular user may be located in a different location within the screen block page 400. The implementation of screen blocks 402 may vary in accordance with different embodiments of the disclosure. For example, a screen block may be implemented in various sizes and shapes that appear on a screen used to visualize the interactive website.

For example, assume a user “Joe Citizen” lives at 88 Main Street in Brentwood, Calif. and that his zip code is 90049 and his phone number is 310-111-1111. A screen block associated with the user “Joe Citizen” is located randomly on the screen block page 400 associated with the zip code 90049. When a user moves the mouse cursor 412 over the particular screen block, the information associated with “Joe Citizen” is displayed in a balloon. A user may filter which screen blocks are displayed in the screen block page 400 using the filter 406. For example, a user may select to view only females between the ages of 25 and 32, or only those persons whose surname begins with “Citi.” In addition, a user may obtain a list of people that satisfy search criteria by using the search 408.

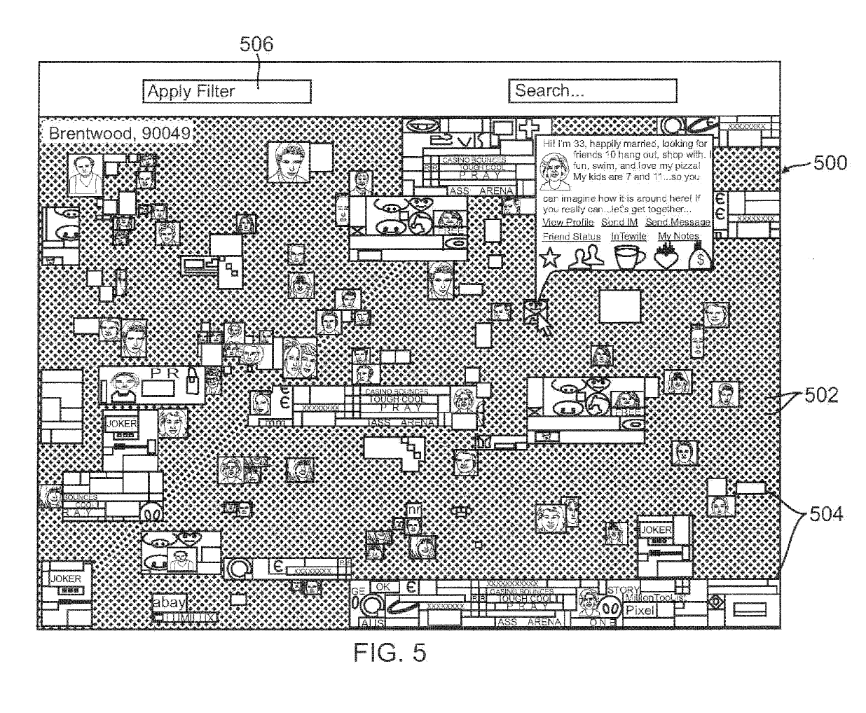

FIG. 5 is a first illustration of a collage page 500 including blank screen blocks 502 and image screen blocks 504. The region displayed in the example collage page 500 is the same zip code described for screen block page 400 supra. The collage page 500 displays a collage of screen blocks, which include blank screen blocks 502 and image screen blocks 504. Each blank screen block 502 is associated with a person who lives within the selected zip code. Each image within the image screen blocks 504 is provided by a user of the interactive website. The image may be a photo, an avatar, or other image, or combination of image(s) and text, which the user desires to use. The user may upload the image or select the image from a plurality of images provided by the system 102. That is, each user living within the zip code may be allowed to upload additional information for display in association with the blank screen block 502 that is assigned to or is associated with that user. In addition, members who may or may not be living within the zip code may be allowed to upload images and text for display in image screen blocks 504 and to upload information for display in association with the uploaded images. The information may include links, media, pictures, text, contact and personal information, advertising material, and other information a user may desire to provide. When a user viewing the collage page 500 moves a mouse cursor over an image screen block 504 or a blank screen block 502, the information associated with the image screen block 504 or blank screen block 502 is displayed for the user. Screen blocks 502, 504 may be randomized on the collage page 500 and therefore may be displayed in different locations upon a refresh of the collage page 500. A user may choose to keep his screen block 504 in a pre-defined segment or stationary location on the collage page 500. Based on the number of image screen blocks 504 to display on the collage page 500, the server 102 may vary the sizes of the screen blocks 502, 504. The server 102 may not display all of the screen blocks 502, 504 associated with a particular zip code on the collage page 500 and may select only some of the screen blocks 502, 504 for display based on filter options 506 of a user. If there are too many screen blocks 502, 504 to display on the collage page 500, the server may randomly select some screen blocks 502 for display while not displaying other screen blocks 502. The system may allow for multiple persons or entities to be associated with a particular block 504. For a block 504 associated with multiple persons or entities, the system may further allow for that block to be categorized as public or private. A private block is a block that is closed to membership except through permission of owners of that private block. Public blocks are all blocks that are not private blocks.

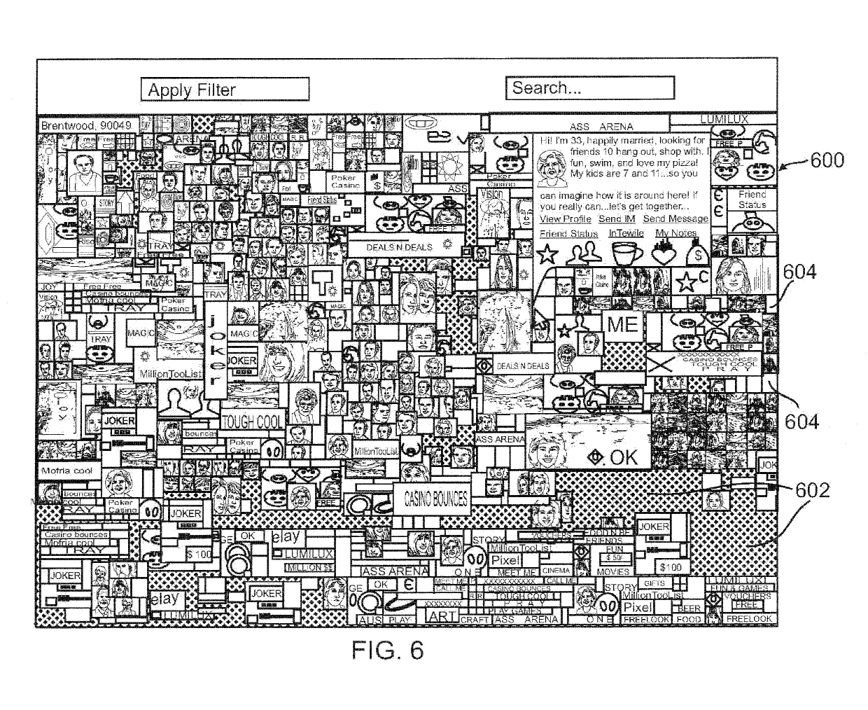

FIG. 6 is a second illustration of the collage page 600 including blank screen blocks 602 and image screen blocks 604. A user of the interactive website may hide the image screen blocks 604 in order to show only the blank screen blocks 602. When a user hides the image screen blocks 604, additional blank screen blocks 602 may be viewed in the collage page 600.

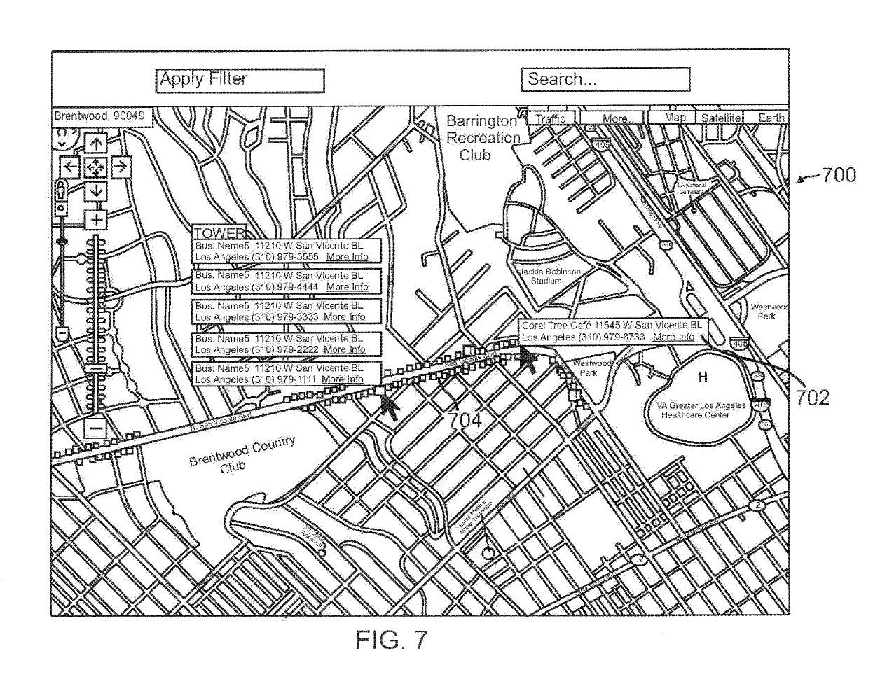

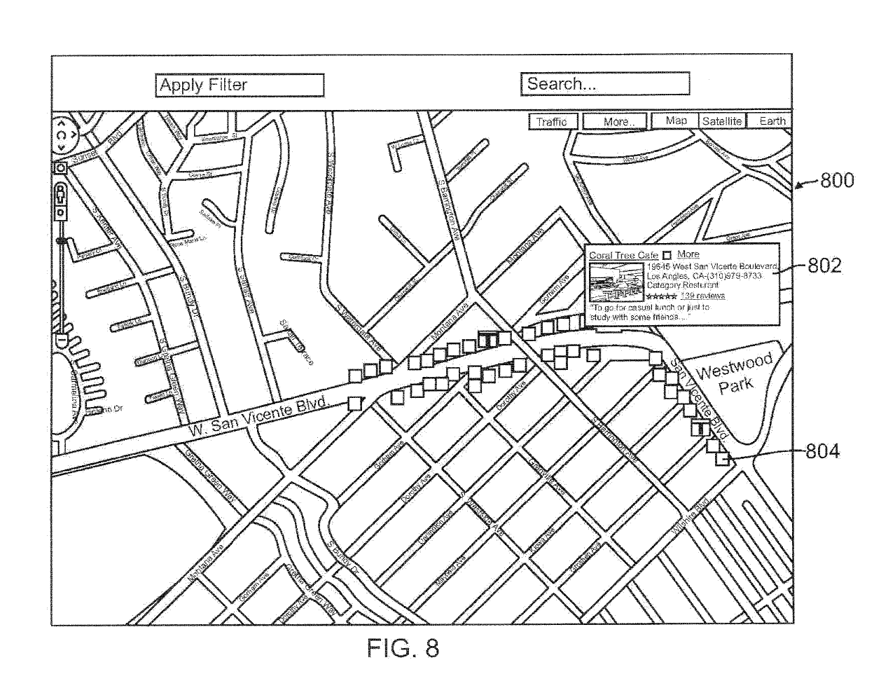

FIG. 7 is a first illustration 700 of a destination map page. FIG. 8 is a second illustration 800 of the destination map page. At any time, a user may view the destination map page. A user may choose to view his/her own geographical location on the destination map, and may further choose to view, on the same or different destination map, the position of any other site user, and these users may choose a destination on a destination map at which to meet. The destination map page displays locations of various businesses in blocks 704, 804 on the map. If the mouse cursor moves over one of the business blocks, more information related to the business is displayed in a balloon (or pop up window) 702, 802. When the mouse cursor moves over one of the business blocks 704, 804, the system may determine whether to show less information (see 702) as shown in the first illustration 700 or more information (see 802) as shown in the second illustration 800. The user may be able to set how much information is displayed in the balloons. The system may allow for multiple businesses or entities to be associated with a particular block. The system may provide, to each user, traffic reports and travel directions to a chosen destination on a destination map, as well as reviews, discount coupons, and other useful information and tools.

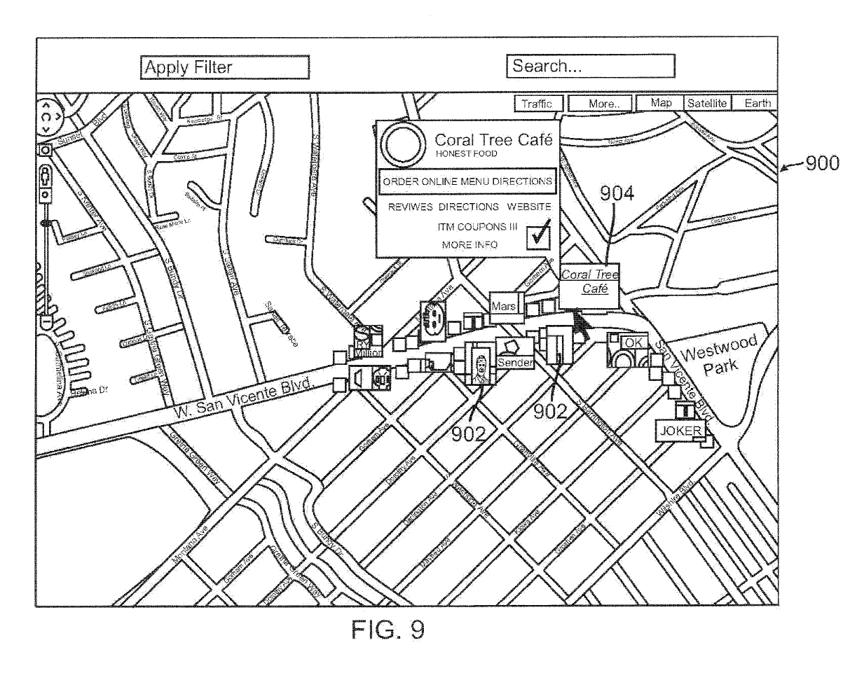

FIG. 9 is a third illustration 900 of the destination map page. As shown in FIG. 9, businesses may be allowed to place images 902 on the destination map page with advertisements. The server may control the size of the images 902. The server may display some images larger than others based on the membership levels of the businesses with advertisements. When the mouse cursor moves over an image, such as image 904, additional information associated with the image 904 may be displayed. The additional information may include business contact information, web links, reviews, menus, coupons and other useful data and tools. The web links may allow users to donate to the businesses, such as to non-profit businesses that operate as charities. Users may obtain coupons to be encouraged to patronize a particular business. Users may also show or hide particular businesses or categories of businesses. For example, a user may be able to hide all businesses except for movie theaters. Users may also search for businesses using keywords, descriptions, locations, and other criteria. The results of such a search may be shown in a tabular list or as blocks or icons on the destination map. The website may allow businesses to improve their standing in such search results through requests made of the website operator.

The exemplary interactive website may provide additional functionality to facilitate networking. The exemplary website may allow users to project themselves into, and join communities in areas, zones or zip code locations other than their home zones, either through the establishment of image screen blocks (e.g., 504, 604) in the target zone, or by registering in the target zone as guest members. The exemplary website may provide functionality to allow other social networking sites to be seamlessly integrated within the exemplary interactive website. With respect to IM, users may view some existing IM groups and allow a user or another IM group to join an existing IM group with permission of the existing IM group. That is, the system may be configured to provide a list of public IM groups and allow a user to drag and drop an IM group within which the user is communicating to one of the public IM groups that have provided permission to join in order to create a chat room with users from both the IM groups. In addition, users may be able to set special icons and/or colors in displayed information in order to visually define certain people as belonging to a group. For example, all people interested in dancing may have an icon or color associated with their displayed information. Users may also include icons or colors in association with businesses in the destination map 700, 800, 900, in order to easily visualize particular types of businesses. Users may also be able to invite other members to particular events and display the event on the destination map. Businesses close to the event may be able to advertise the ability to provide special services to those who attend the event. For example, a user may invite members to a party at her house, and catering companies in the vicinity of her house may be able to view the event and advertise the ability to provide catering services for the party. Through the exemplary website, users may be able to send promotional material to other members or their personal contacts. The promotional material may contain information promoting various businesses listed in the destination map.

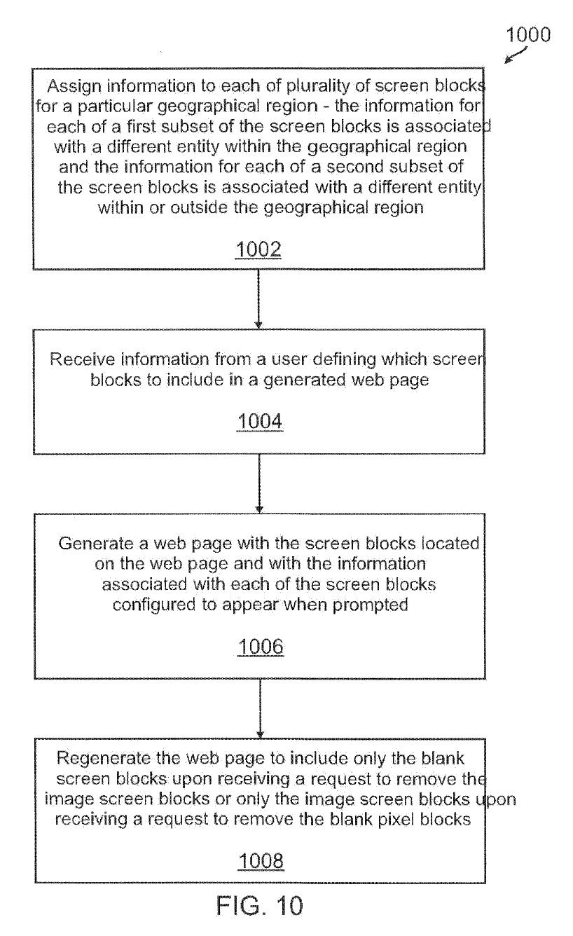

FIG. 10 is a flow chart 1000 of an exemplary method of the interactive website. The method assigns information to each of a plurality of screen blocks for a particular geographical region (1002). The screen blocks may include blank screen blocks and image screen blocks. Blank screen blocks may show a border to delineate the screen blocks, but do not show other graphical information. Image screen blocks contain an image. The information for each of a first subset of the screen blocks is associated with a different entity within the geographical region and the information for each of a second subset of the screen blocks is associated with a different entity within or outside the geographical region (1002). That is, some of the screen blocks (i.e., a first subset of the screen blocks) are blank screen blocks and the blank screen blocks are each associated with a different entity within the geographical region, and some of the screen blocks (i.e., a second subset of the screen blocks) are image screen blocks and the image screen blocks are each associated with a different entity that may be within or outside the geographical region (1002). The method may additionally receive information from a user defining which screen blocks to include in a generated web page (1004). In addition, the method generates a web page with the screen blocks located on the web page and with the information associated with each of the screen blocks configured to appear when prompted (1006).

Locating screen blocks on the screen block page without reference to a geographical map provides users some anonymity, as other users may not necessarily know the location of the user within the particular area or zip code, and also facilitates the inclusion, into any given community, of users who do not actually reside in that community's geographical area, since they may be so included without providing a specific address. The screen blocks may be sorted on the web page based on various criteria, such as for example, alphabetical by last name. Alternatively, the screen blocks may be located randomly on the web page, as they are by default. Locating the screen blocks randomly on the web page may facilitate a likelihood of meeting different people, as users may tend to click on or move their mouse over the same areas of the screen.

As discussed supra, the geographical region may be defined by a zip code. The first subset of the screen blocks may include all of the screen blocks, the second subset may be empty and contain no image screen blocks, and each of the screen blocks may be associated with a different entity within the geographical region. That is, in one configuration, all the screen blocks may be blank screen blocks as shown in FIG. 4 and the first subset of screen blocks may include one screen block for each entity known to be located in the geographical region. Alternatively, the screen blocks may include both blank screen blocks and image screen blocks containing images. The first subset includes the blank screen blocks and the second subset includes the image screen blocks. The image screen blocks may be interspersed randomly with the blank screen blocks, or may be placed by the entities they represent. The method may further regenerate the web page to include only the blank screen blocks upon receiving a request to remove the image screen blocks (1008). Conversely, the method may regenerate the web page to include only the image screen blocks upon receiving a request to remove the blank screen blocks (1008), or it may include only certain blank and/or image screen blocks based on a request to filter out unwanted blocks. The images may be advertisements, messages or personal images (e.g., photos). In one configuration, at least one of the screen blocks may be associated with a plurality of entities (people and/or businesses) and the information associated with the at least one of the screen blocks may include information for each of the plurality of entities. That is, one screen block may be associated with multiple entities and information on the multiple entities may be shown in a balloon, or in a plurality of balloons, when a cursor moves over the screen block.

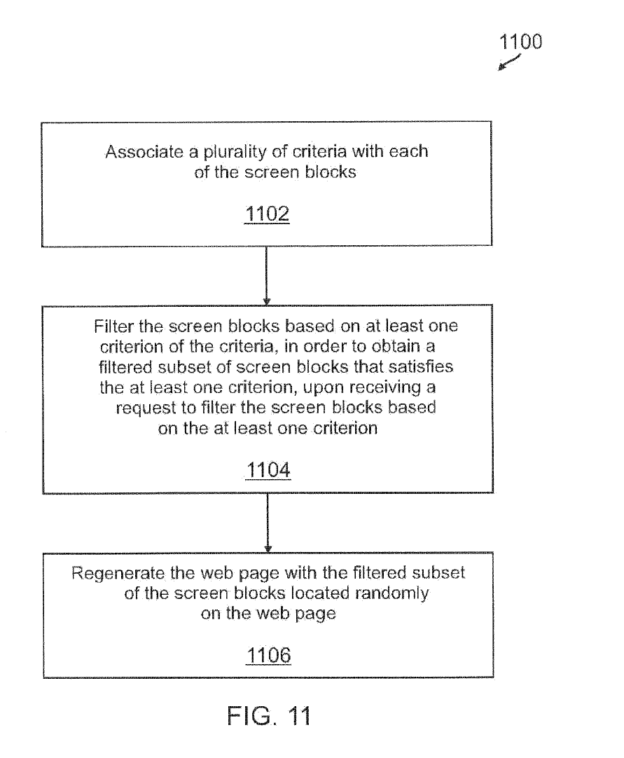

FIG. 11 is a flow chart 1100 of an exemplary method of the interactive website. The method associates a plurality of criteria with each of the screen blocks (1102). In addition, the method filters the screen blocks based on at least one criterion of the criteria, in order to obtain a filtered subset of screen blocks that satisfies the at least one criterion, upon receiving a request to filter the screen blocks based on the at least one criterion (1104). Furthermore, the method regenerates the web page with the filtered subset of the screen blocks located on the web page (1106).

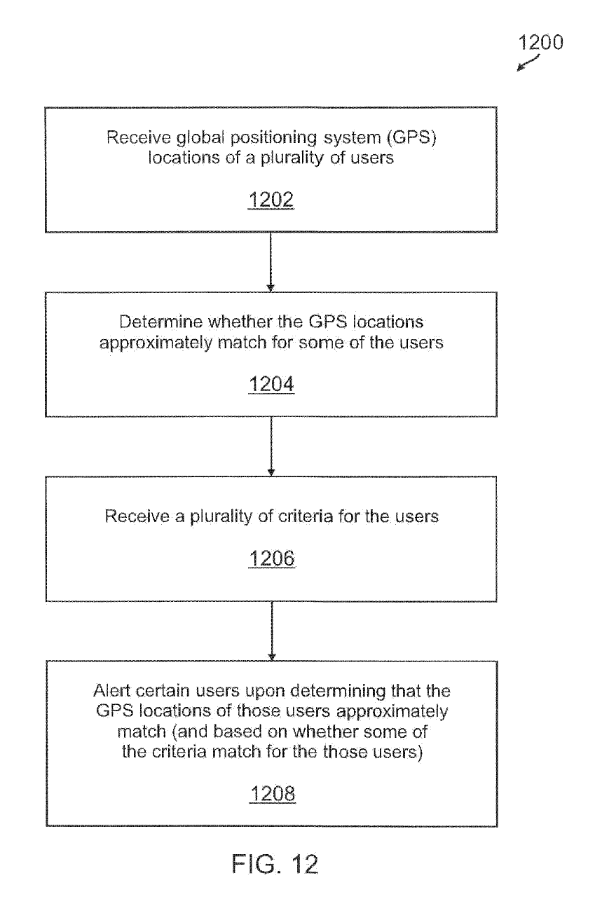

FIG. 12 is a flow chart 1200 of an exemplary method of the interactive website. The method receives global positioning system (GPS) locations of a plurality of users (1202) and determines whether the GPS locations approximately match for some of the users (1204). The method may further receive a plurality of criteria for the users (1206). The method then alerts certain users upon determining that the GPS locations of those users approximately match (1208). In one configuration, the method alerts further based on whether some of the criteria match for those users (1208). The method may report such matches in a tabular list or directly on the destination map (discussed supra) utilizing one icon or one screen block for each match.

Referring again to FIG. 4, the exemplary method is implemented by the server 102, which collects and/or receives information about entities (e.g., people, businesses) with screen blocks in the screen block page 400. The information collected may include a record of daily activities and locations to which the person has gone on the destination map page. The locations to which a person has gone may be collected from the person or may alternatively, or additionally, be collected from GPS data received through periodic transmissions from the person's cell phone or other mobile device. The server 102 collects the GPS information and stores other user-provided information. The server 102 may provide real-time GPS user locations on the destination map for other users to see. A particular user location may be displayed by a moving marker on the destination map. In addition, the server 102 may match people together based on the collected information provided by the people regarding their individual activities, locations, feelings and thoughts. The collected information may further include information such as personal interests, hobbies, likes/dislikes, plans, feelings, philosophies, background, education, gender, and age.

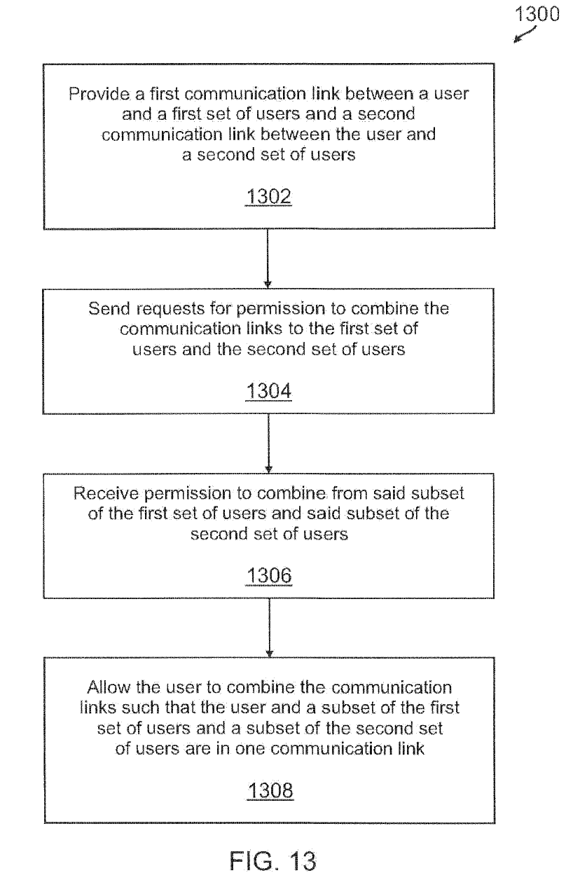

FIG. 13 is a flow chart 1300 of an exemplary method. The method provides a first communication link between a user and a first set of users and a second communication link between the user and a second set of users (1302). In addition, the method may send requests for permission to combine the communication links to the first set of users and the second set of users (1304) and receive permission to combine from said subset of the first set of users and said subset of the second set of users (1306). The method allows the user to combine the communication links such that the user and a subset of the first set of users and a subset of the second set of users are in one communication link (1308). The method may allow the user to combine the communication links by allowing the user to drag and drop at least one indicator of at least one of the first communication link or the second communication link to prompt the combining.

Referring again to FIG. 1, the server 102 may include means for assigning information to each of a plurality of screen blocks for a particular geographical region. The information for each of a subset of the screen blocks is associated with a different entity within the geographical region. In addition, the server 102 may include means for generating a web page with the screen blocks located on the web page and with the information associated with each of the screen blocks configured to appear when prompted. The server 102 may further include means for regenerating the web page to include only the blank screen blocks upon receiving a request to remove the image screen blocks. The server 102 may further include means for associating a plurality of criteria with each of the screen blocks; means for filtering the screen blocks based on at least one criterion of the criteria, in order to obtain a filtered subset of screen blocks that satisfy the at least one criterion, upon receiving a request to filter the screen blocks based on the at least one criterion; and means for regenerating the web page with the filtered subset of the screen blocks located on the web page. The server may further include means for receiving information from a user defining which screen blocks to include in the generated web page. The aforementioned means is the processor 110 configured to perform the aforementioned means.

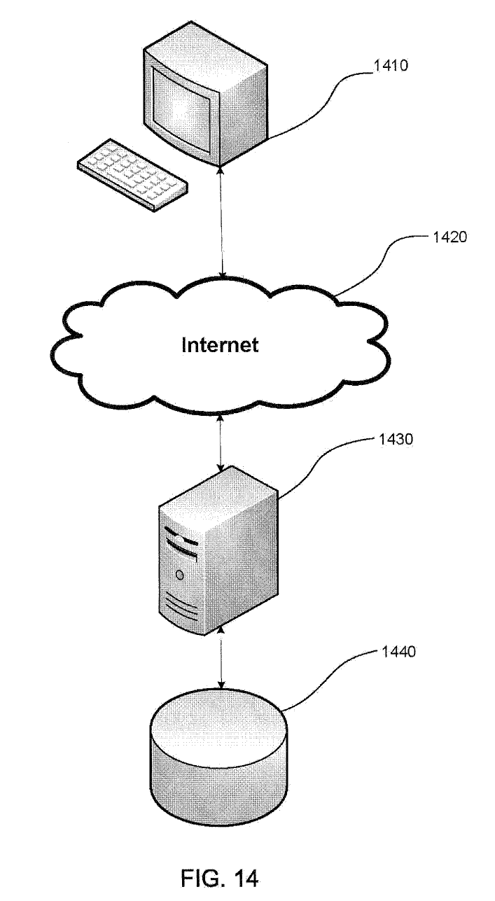

FIG. 14 shows a three-tier client-server architecture. More generally, client-server architectures are represented by multi-tier (or n-tier) systems. In the first embodiment, as shown in FIG. 1, the system may be implemented with the server 102 and client computer 106. In a second embodiment, the system may be implemented in a three-tier system with presentation, application processing, and data management tiers. One skilled in the art will recognize that other tiers may be included and the tiers represented may be implemented in various embodiments in accordance with the disclosure. For example, the application and data management tiers may reside in one server, may each reside on its own server, or operate through a distributed system. In a distributed system, each tier may reside on multiple servers that are geographically located together or apart. The application and data management tiers may also be implemented through cloud computing as an extension of the distributed system, and may include mobile systems or devices.

The three-tier architecture has the following three tiers:

1) Presentation tier. The presentation tier is the user interface for interfacing with a client computer 106, 1410 or user of the application. This tier accepts input from the client computer 106, 1410 or user and outputs results from the lower tiers. For example, in a data entry application, the presentation tier will take data entries in the form, for example, of user names, addresses, and phone numbers for processing and storage into the database 1440. The user can later retrieve the data entered, where the presentation layer receives the input search request and displays the information gathered in the lower tiers.

2) Application tier (business logic, logic, data access, middle tier). The application tier, also called a logic tier, performs the data processing and other business routines on an application server 1430. For example, in a simple data entry application, the logic tier merely converts the data entered into a form suitable for storage. During retrieval, the logic tier retrieves the database data for use in the presentation tier. In more complicated business applications, the logic tier applies software routines, algorithms, filtering, searching, sorting, and other processes and manipulation to data. The Application tier may be implemented in various means, including using software languages such as Java, ASP.NET, PHP, ColdFusion, Ruby, etc.

3) Database tier. The database server 1440 provides storage and persistent data. Data is kept neutral and independent from the application server 1430 and business logic. A database tier provides scalability and performance. The database tier may be implemented in various embodiments in accordance with the disclose including systems such as Oracle® server, SQL server, MySQL®, MS Access®, using languages such as SQL or other query languages. Data is stored and retrieved through operations called queries.

In the instant application, the database 1440 stores information including screen block information and member information. Referring back to FIG. 14, the database 1440 is initially populated with information. An entry is created for each member of a given community. The initial member information may come from various sources including public or private databases, online services, CD-ROMs, etc. When a user registers with the service, an entry is created for the user if the user is not already in the system. Once registered, a user may add information to his/her entry in the system.

Mappings are created between the members in the system and the screen blocks. In an example, the mappings are created on a neighborhood scale, with members within each neighborhood randomly mapped to screen blocks. In addition to a completely random mapping of members to screen blocks, other mappings are possible. For example, members may be mapped within a predefined radius so that a member located more than a predefined distance from the member's actual location is not displayed. In another example, members may be mapped in a neighborhood so that the area density of members is evenly distributed across the neighborhood. The mapping of screen blocks to members may be persistent, or the mapping may change at certain times. Mappings may be one-to-one, one-to-many, or many-to-many. A one-to-one mapping would assign one member to one screen block, one-to-many would assign multiple users to a screen block or multiple screen blocks to a member. In a many-to-many mapping, each member and each screen block may be assigned to multiple screen blocks and multiple members, respectively.

The application server 1430 and client computer 1410 are configured to perform the operations described supra, and the Internet 1420 acts as an information conduit. As described supra, the client computer 1410 may be implemented in various embodiments in accordance with the disclosure, such as a personal computer or a mobile device including a wireless cellular phone or a tablet computer.

One skilled in the art will recognize that the system of FIG. 14 may be implemented in various embodiments in addition to or in place of the three-tier system, such as through a monolithic system or a Model-View-Controller paradigm.

The various aspects of this disclosure are provided to enable one of ordinary skill in the art to practice the present invention. Modifications to various aspects of an interactive website presented throughout this disclosure will be readily apparent to those skilled in the art, and the concepts disclosed herein may be extended to other applications. Thus, the claims are not intended to be limited to the various aspects of the interactive website presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of an interactive website, comprising:
assigning information to each of a plurality of screen blocks for a particular geographical region, the information for each of a first subset of the screen blocks being associated with a different entity within the geographical region and the information for each of a second subset of the screen blocks being associated with a different entity within or outside the geographical region; and
generating a web page with the screen blocks located on the web page and with the information associated with each of the screen blocks configured to appear when prompted.

2. The method of claim 1, wherein the screen blocks are located randomly on the web page.

3. The method of claim 1, wherein the geographical region is defined by a zip code.

4. The method of claim 1, wherein the first subset of the screen blocks includes all of the screen blocks, the second subset is empty, and each of the screen blocks is associated with a different entity within the geographical region.

5. The method of claim 4, wherein the first subset of the screen blocks includes one screen block for each entity known to be located in the geographical region.

6. The method of claim 1, wherein the screen blocks comprise both blank screen blocks and image screen blocks containing images, the first subset comprising the blank screen blocks and the second subset comprising the image screen blocks.

7. The method of claim 6, wherein the image screen blocks are interspersed randomly with the blank screen blocks.

8. The method of claim 6, further comprising regenerating the web page to include only the blank screen blocks upon receiving a request to remove the image screen blocks.

9. The method of claim 6, further comprising regenerating the web page to include only the image screen blocks upon receiving a request to remove the blank screen blocks.

10. The method of claim 6, wherein the images are advertisements, messages or personal images.

11. The method of claim 1, further comprising:
associating a plurality of criteria with each of the screen blocks;
filtering the screen blocks based on at least one criterion of the criteria, in order to obtain a filtered subset of the screen blocks that satisfy the at least one criterion, upon receiving a request to filter the screen blocks based on the at least one criterion; and
regenerating the web page with at least one of the filtered subset of the screen blocks located randomly on the web page or the filtered subset of the screen blocks in a tabular list.

12. The method of claim 1, wherein at least one of the screen blocks is associated with a plurality of entities and the information associated with the at least one of the screen blocks comprises information for each of the plurality of entities.

13. The method of claim 1, further comprising receiving information from a user defining which screen blocks to include in the generated web page, wherein the web page is generated to include only the screen blocks corresponding to the received information.

14. The method of claim 1, wherein the information of at least one screen block of the first subset of the screen blocks is associated with an entity outside the geographical region.

15. An apparatus for providing an interactive website, comprising:
a processing system configured to:
assign information to each of a plurality of screen blocks for a particular geographical region, the information for each of a first subset of the screen blocks being associated with a different entity within the geographical region and the information for each of a second subset of the screen blocks being associated with a different entity within or outside the geographical region; and
generate a web page with the screen blocks located on the web page and with the information associated with each of the screen blocks configured to appear when prompted.

16. The apparatus of claim 15, wherein the screen blocks are located randomly on the web page.

17. The apparatus of claim 15, wherein the geographical region is defined by a zip code.

18. The apparatus of claim 15, wherein the first subset of the screen blocks includes all of the screen blocks, the second subset is empty, and each of the screen blocks is associated with a different entity within the geographical region.

19. The apparatus of claim 18, wherein the first subset of the screen blocks includes one screen block for each entity known to be located in the geographical region.

20. The apparatus of claim 15, wherein the screen blocks comprise both blank screen blocks and image screen blocks containing images, the first subset comprising the blank screen blocks and the second subset comprising the image screen blocks.

21. The apparatus of claim 20, wherein the image screen blocks are interspersed randomly with the blank screen blocks.

22. The apparatus of claim 20, wherein the processing system is further configured to regenerate the web page to include only the blank screen blocks upon receiving a request to remove the image screen blocks.

23. The apparatus of claim 20, wherein the processing system is further configured to regenerate the web page to include only the image screen blocks upon receiving a request to remove the blank screen blocks.

24. The apparatus of claim 20, wherein the images are advertisements, messages or personal images.

25. The apparatus of claim 15, wherein the processing system is further configured to:
associate a plurality of criteria with each of the screen blocks;
filter the screen blocks based on at least one criterion of the criteria, in order to obtain a filtered subset of the screen blocks that satisfies the at least one criterion, upon receiving a request to filter the screen blocks based on the at least one criterion; and
regenerate the web page with the filtered subset of the screen blocks located randomly on the web page.

26. The apparatus of claim 15, wherein at least one of the screen blocks is associated with a plurality of entities and the information associated with the at least one of the screen blocks comprises information for each of the plurality of entities.

27. The apparatus of claim 15, wherein the processing system is further configured to receive information from a user defining which screen blocks to include in the generated web page, wherein the web page is generated to include only the screen blocks corresponding to the received information.

28. The apparatus of claim 15, wherein the information of at least one screen block of the first subset of the screen blocks is associated with an entity outside the geographical region.

29. A computer program product, comprising:
a computer-readable medium comprising code for:
assigning information to each of a plurality of screen blocks for a particular geographical region, the information for each of a first subset of the screen blocks being associated with a different entity within the geographical region and the information for each of a second subset of the screen blocks being associated with a different entity within or outside the geographical region; and
generating a web page with the screen blocks located on the web page and with the information associated with each of the screen blocks configured to appear when prompted.

30. The computer program product of claim 29, wherein the screen blocks are located randomly on the web page.

31. The computer program product of claim 29, wherein the geographical region is defined by a zip code.

32. The computer program product of claim 29, wherein the first subset of the screen blocks includes all of the screen blocks, the second subset is empty, and each of the screen blocks is associated with a different entity within the geographical region.

33. The computer program product of claim 32, wherein the first subset of the screen blocks includes one screen block for each entity known to be located in the geographical region.

34. The computer program product of claim 29, wherein the screen blocks comprise both blank screen blocks and image screen blocks containing images, the first subset comprising the blank screen blocks and the second subset comprising the image screen blocks.

35. The computer program product of claim 34, wherein the image screen blocks are interspersed randomly with the blank screen blocks.

36. The computer program product of claim 34, wherein the computer-readable medium further comprises code for regenerating the web page to include only the blank screen blocks upon receiving a request to remove the image screen blocks.

37. The computer program product of claim 34, wherein the computer-readable medium further comprises code for regenerating the web page to include only the image screen blocks upon receiving a request to remove the blank screen blocks.

38. The computer program product of claim 34, wherein the images are advertisements, messages or personal images.

39. The computer program product of claim 29, wherein the computer-readable medium further comprises code for:
associating a plurality of criteria with each of the screen blocks;
filtering the screen blocks based on at least one criterion of the criteria, in order to obtain a filtered subset of the screen blocks that satisfies the at least one criterion, upon receiving a request to filter the screen blocks based on the at least one criterion; and
regenerating the web page with the filtered subset of the screen blocks located randomly on the web page.

40. The computer program product of claim 29, wherein at least one of the screen blocks is associated with a plurality of entities and the information associated with the at least one of the screen blocks comprises information for each of the plurality of entities.

41. The computer program product of claim 29, wherein the computer-readable medium further comprises code for receiving information from a user defining which screen blocks to include in the generated web page, wherein the web page is generated to include only the screen blocks corresponding to the received information.

42. The computer program product of claim 29, wherein the information of at least one screen block of the first subset of the screen blocks is associated with an entity outside the geographical region.

43. An apparatus for providing an interactive website, comprising:
means for assigning information to each of a plurality of screen blocks for a particular geographical region, the information for each of a first subset of the screen blocks being associated with a different entity within the geographical region and the information for each of a second subset of the screen blocks being associated with a different entity within or outside the geographical region; and
means for generating a web page with the screen blocks located on the web page and with the information associated with each of the screen blocks configured to appear when prompted.

44. The apparatus of claim 43, wherein the screen blocks are located randomly on the web page.

45. The apparatus of claim 43, wherein the geographical region is defined by a zip code.

46. The apparatus of claim 43, wherein the first subset of the screen blocks includes all of the screen blocks, the second subset is empty, and each of the screen blocks is associated with a different entity within the geographical region.

47. The apparatus of claim 46, wherein the first subset of the screen blocks includes one screen block for each entity known to be located in the geographical region.

48. The apparatus of claim 43, wherein the screen blocks comprise both blank screen blocks and image screen blocks containing images, the first subset comprising the blank screen blocks and the second subset comprising the image screen blocks.

49. The apparatus of claim 48, wherein the image screen blocks are interspersed randomly with the blank screen blocks.

50. The apparatus of claim 48, further comprising means for regenerating the web page to include only the blank screen blocks upon receiving a request to remove the image screen blocks.

51. The apparatus of claim 48, further comprising means for regenerating the web page to include only the image screen blocks upon receiving a request to remove the blank screen blocks.

52. The apparatus of claim 48, wherein the images are advertisements, messages or personal images.

53. The apparatus of claim 43, further comprising:
means for associating a plurality of criteria with each of the screen blocks;
means for filtering the screen blocks based on at least one criterion of the criteria, in order to obtain a filtered subset of the screen blocks that satisfies the at least one criterion, upon receiving a request to filter the screen blocks based on the at least one criterion; and
means for regenerating the web page with the filtered subset of the screen blocks located randomly on the web page.

54. The apparatus of claim 43, wherein at least one of the screen blocks is associated with a plurality of entities and the information associated with the at least one of the screen blocks comprises information for each of the plurality of entities.

55. The apparatus of claim 43, further comprising means for receiving information from a user defining which screen blocks to include in the generated web page, wherein the web page is generated to include only the screen blocks corresponding to the received information.

56. The apparatus of claim 43, wherein the information of at least one screen block of the first subset of the screen blocks is associated with an entity outside the geographical region.
